(19) United States
(12) Patent Application Publication
(10) Pub. No.: US 2014/0258455 A1
(43) Pub. Date: Sep. 11, 2014

(54) Geolocated Network

(71) Applicant: Microchip Technology Incorporated, Chandler, AZ (US)

(72) Inventor: Joseph Julicher, Maricopa, AZ (US)

(21) Appl. No.: 14/199,387

(22) Filed: Mar. 6, 2014

Related U.S. Application Data
(60) Provisional application No. 61/775,517, filed on Mar. 9, 2013.

(51) Int. Cl. H04L 29/08

(52) U.S. Cl. CPC H04L 67/18
USPC 709/217; 709/223

(57) ABSTRACT

A method according to embodiments comprises creating a geolocated network of nodes representing a network of devices where each node is identified in the geolocated network by an address that is formed using the geographical location of the node. Messages are transmitted within the geolocated network from sender to geographic targets. Message are received by nodes in the network and each recipient node determines whether it is an intended recipient of the message by evaluating whether it is geographically located within the geographic targets of the message. The geographic targets of messages can be comprised of path information where the path information specifies that recipient nodes geographically located along the path are intended recipients of the message. Nodes within the geolocated network participate in routing of messages by forwarding messages along paths specified by the path information, if the node determines it is located along the path.

### CROSS-REFERENCE To RELATED APPLICATIONS

This application claims the benefit of U.S. Provisional Application No. 61/775,517 filed on Mar. 9, 2013, which is incorporated herein in its entirety.

### TECHNICAL FIELD

The present disclosure relates to networks, in particular to networks comprised of geolocated nodes.

### BACKGROUND

In a conventional computer network, devices that comprise the network are identified by Media Access Control (MAC) addresses and Internet Protocol (IP) addresses. A MAC address permanently and uniquely identifies a network-enabled device irrespective of the network to which the device belongs. An IP address, however, identifies a device within a particular computer network; with this identification typically lasting only as long as the node is connected to the network.

In conventional networks that utilize MAC and IP addresses, routing of messages within the network is typically accomplished using centralized databases, such as routing tables and forwarding tables. Servers use these databases to determine whether a message is directed to a recognized network node or whether the message must be forwarded to a another server that maintains a different database of node addresses. However, as the size of a network increases, the complexity of conventional routing databases also increases. And, as the size and complexity of routing databases increase, the time required to determine whether a node address is present in the database also increases. This decreases the maximum number of network operations that can be supported by the server as each request takes longer to complete. The efficiency of these routing databases is further degraded due to the burden of updating entries in the database to include accurate and timely node address information. This burden increases further when nodes are mobile since address information needs to be maintained accurately and updated in a timely fashion and updates must be coordinated across more servers.

These problems with conventional networks are further compounded when attempting to route messages based on geographic location of individual nodes. Since nodes in conventional networks are strictly logically addressed, every message transmission that is delivered based on the geographic location of the network nodes requires undertaking this translation of geographical node identification information to logical routing information. Implementing such a system becomes increasingly infeasible as the geolocated network of nodes increases in size.

Individual servers that maintain conventional routing and forwarding tables have practical limits on the number of nodes that can be supported and the number of simultaneous requests that can processed. Even though modern network servers are highly optimized in order to maximize message routing capabilities, an individual server is insufficient for providing the routing services required by large networks. The inability of a single server to provide routing services is magnified where the nodes can be mobile. In mobile wireless networks, simply scaling the ability of individual servers to accommodate more requests does not address the problems in providing routing services for a large number of nodes.

One way that conventional networks address scalability problems is by using network hierarchies so that servers at each level of the hierarchy provide different routing services. Hierarchies of network servers are used to split message routing determinations into different levels of granularity; with servers dedicated to providing routing services at each of the levels of granularity and with servers at each level of the hierarchy generally providing routing only at one level of granularity. Routing services in conventional TCP/IP networks are provided using hierarchical servers with top-level servers routing messages to sub-networks based only on top-level domain information and low-level servers routing messages to particular nodes on the network. This technique has been proven to scale message routing capabilities where logical addresses are used but is not suitable for routing based on geographic location of individual nodes.

Another technique used to provide scalability in conventional networks is to replicate routing and forwarding tables across multiple servers. Replicated tables allow identical routing responsibilities to be shared by multiple servers. Because replication distributes the computational burden of providing routing services, it can alleviate bottlenecks created in conventional networks. However, providing replicated routing servers requires distributing and maintaining accurate routing information in all replicated servers. The burden of setting up and maintaining replicated servers becomes increasingly complicated as networks grow larger in size. Additionally, any changes in the replicated data must be disseminated quickly and precisely because inconsistent routing information results in inefficiencies and message delivery failures that further burden the network. As before, this difficulty is compounded when nodes in the network are mobile. The problems with replicating data in networks of mobile nodes are especially evident when attempting to route messages based on the geographic location of the nodes.

Consequently, it is desirable to be able to efficiently route messages with a network based only on the geographic location of the nodes in the network. It is further desirable to have an addressing scheme which allows individual nodes in a network to determine, based on their geographic location, if they are intended recipients of network events and commands without the complexity and burden of maintaining conventional routing databases.

### SUMMARY

Conventional routing based on geographic location of the nodes is inefficient and requires substantial routing infrastructure. Hence, there is a need for a geolocated network that routes nodes based on a nodes location, which is encoded in the nodes address. These and other drawbacks in the prior art are overcome in large part by a system and method according to embodiments of the present invention.

According to an embodiment, a method for communicating within a network of devices comprises creating a network of nodes wherein nodes are created for devices in the network and identifying each node by an address wherein the address is formed using geographical information.

According to a further embodiment, the method for communicating within a network of devices further comprises transmitting a message within the network of nodes from a sender node to one or more geographic targets, wherein the message is comprised of message content; receiving the message at the one or more recipient nodes, wherein each recipient node determines whether it is geographically located within the geographic targets of the message; and processing the message content of the received message by a recipient node, if the recipient node determines it is located within any of the geographic targets of the message. In some embodiments, the method further comprising transmitting the message wherein a geographic target of the message is comprised of path information; determining whether the recipient node is geographically located within the one or more geographic targets of the messages by determining whether the recipient node is geographically located along a path specified by the path information; and forwarding the message by the recipient node if the recipient node determines it is geographically located along a path specified by the path information but is not an endpoint of the path wherein the message is forwarded along the path specified by the path information. In some embodiments, the geographic target of the message consists of global positioning system (GPS) coordinates, a distance from a geographic location, a rectangle defined by a set of geographic coordinates or a polygon defined by a set of geographic coordinates. In some embodiments, the message includes an alarm notification. In some embodiments, the path information includes instructions for forwarding the message along a path specified by the path information. In some embodiments, the message is further comprised of a message address and a message address type bit that specifies the type of geographic target for the message.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 illustrates a geolocated network of streetlamps located on a grid and demonstrates the delivery of message from a sender node to a recipient node that is connected to the sender node via wired connection.

FIG. 2 illustrates a geolocated network of streetlamps located on a grid and demonstrates the delivery of a message from a sender node to a recipient node via a wireless broadcast message.

FIG. 3 illustrates a geolocated network of streetlamps located on a grid and demonstrates the delivery of a message from a sender node to a set of recipients nodes geographically located within a range of coordinates on the grid.

FIG. 4 illustrates a geolocated network of streetlamps located on a grid and demonstrates the delivery of a message from a sender node to a set of recipients nodes located along a path from the sender node to a target location.

FIG. 5 illustrates a geolocated network of streetlamps located on a grid and demonstrates the delivery of a message from a sender node to a recipients node that is not directly reachable by the sender node where delivery is via an intermediary recipient node that forwards the message from the sender to the recipient.

FIG. 6 illustrates the formation of a message that includes an address for the recipient node based on the recipient's geographic coordinates.

FIG. 7 illustrates the formation of a message that includes an address for the recipient node based on the recipient's geographic coordinates and an address type bit.

### DETAILED DESCRIPTION

The disclosure and various features and advantageous details thereof are explained more fully with reference to the exemplary, and therefore non-limiting, embodiments illustrated in the accompanying drawings and detailed in the following description. Descriptions of known programming techniques, computer software, hardware, operating platforms and protocols may be omitted so as not to unnecessarily obscure the disclosure in detail. It should be understood, however, that the detailed description and the specific examples, while indicating the preferred embodiments, are given by way of illustration only and not by way of limitation. Various substitutions, modifications, additions and/or rearrangements within the spirit and/or scope of the underlying inventive concept will become apparent to those skilled in the art from this disclosure.

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms.

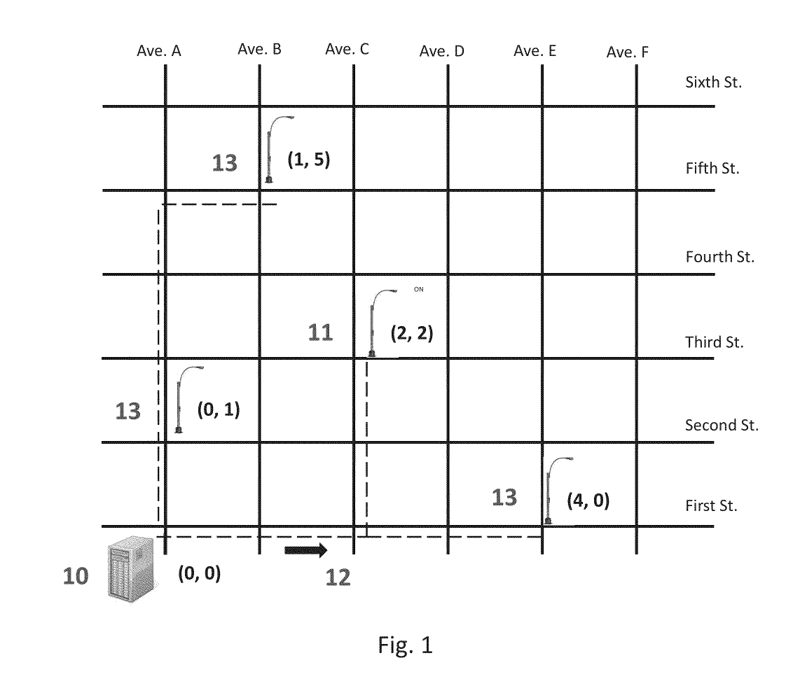

FIG. 1 illustrates an exemplary embodiment that is a grid of streetlamps connected to form a geolocated network of nodes. The streetlamps can be connected via wired or wireless network connections. Messages are sent from a sender node 10 to a recipient node 11. The sender node can be a central node with special-purpose command functionality or any other node in the network. Each node in the geolocated network is located at a specific geographic coordinate, with sender node 10 located at (0,0) and recipient node 11 located at (2,2). The location of sender node 10 is incorporated into the node's address in the geolocated network (e.g., “0×0”) and the geographic location of recipient node 11 is incorporated into its geolocated network address (“2×2”). Multiple nodes can be located at the same geographic coordinates. In this illustrative example, the coordinate system is a simple coordinate plane. However, the coordinate system can be any geographic coordinate systems, such as GPS and latitude and longitude.

A message 12 is dispatched from sender node 10. The message 12 includes message content and a target location. The message content can include routing instructions, instructions requesting data or an action from recipient nodes, status information, the location of the sender node 10, locations of other nodes, or any other instructions or data. The message content can be comprised of encrypted information. The target location of the message 12 defines the geographic coordinates of the intended recipient nodes to which the message 12 is directed. The target location can be a single geographic coordinate or a range of geographic coordinates. Ranges of geographic coordinates can be represented as any geometric two-dimensional or three-dimensional shape. The sender node 10 dispatches the message 12 within the geolocated network as a wireless broadcast message or along wired connections or by any communication protocol that enables messages to be distributed in a computer network.

The message 12 is received by the recipient node 11. The recipient node 11 determines whether it is an intended recipient of the message 12. The recipient node 11 makes this determination by comparing its own geographic location to geographic coordinates specified by the target location of the message 12. The recipient node 11 is an intended recipient node if its geographic location is the same as the target location specified by the message 12 or falls within a range of coordinates specified by the target location of message 12. The determination that recipient nodes 11 is an intended recipient is accomplished by comparing the network address of recipient node 11 to the target location of message 12. For example, the recipient node 11 geographically located at (2,2) would compare its address (e.g., “2×2”) to the target location of message 12 (i.e., nodes located at geographic location (2,2)). The determination of whether a recipient node's geographic location is within the target location of the message can be made according to algorithms and calculations known in the art. However, no address or location lookups are required by a recipient node to determinate whether it is an intended recipient node since the geographic location of recipient node is encoded in its network address. If any lookups are required in determining whether a recipient node is an intended recipient node, these lookups would be incident to the calculation of whether the recipient node's location is within the target location of the message. If the recipient node 12 determines it is an intended recipient of the message 12, the recipient node 11 then processes the message content specified by the message 12. The recipient node 11 can be required to authenticate itself in order to access the message content of the message 12.

In this manner, messages can be transmitted within a geolocated network of streetlamp nodes, such as the network illustrated in FIG. 1. Each streetlamp node is located at a fixed, geographic location. Upon being commissioned, each streetlamp node is programmed with its geographic location. Each streetlamp can be connected as a node within the geolocated network via a variety of networking options. For example, a streetlamp node can be connected to a central command node via a wireless connection. A streetlamp node can also be connected wirelessly to neighboring streetlamp nodes that are geographically located within the wireless broadcast range of the streetlamp node. A streetlamp node can also be connected directly to one or more neighboring nodes via wired connections. A node, such as the streetlamp node of FIG. 1, can be connected to the geolocated network of nodes via any combination of these types of network connections.

A messages dispatched by the sender streetlamp node is received by one or more recipient streetlamps nodes within the network. In FIG. 1, the sender streetlamp node 10 is a central command node that is geographically located at (0, 0). The sender streetlamp node 10 dispatches a message 12 addressed to a intended recipient streetlamp node 11 located at (2, 2), the message content of the message 12 directing the streetlamp at this location to turn on immediately. In this example, the message 12 is transmitted via a direct, wired connection between the two streetlamps. Upon receipt of the message 12, the recipient streetlamp node 11 compares its own geographic coordinates encoded in its network address, (e.g., “2×2”), to the geographic target location specified by the message 12, also (2,2), and determines that it is an intended recipient node of the message 12. No logical address information for sender node 10 or recipient node 11 is utilized in the transmission of message 12 between these two nodes. The recipient streetlamp node can then process the instructions delivered via the message content of the message 12 and switch to an on state.

The sender node 10 might be able to dispatch message 12 strictly to intended recipient node 11 or sender node 10 might broadcast message 12 to multiple recipient nodes. In the broadcast scenario, the sender node 10 need not make an effort to determine which of its wired connections provides a path to intended recipient 11. Instead, all nodes in the geolocated network of nodes are recipient nodes of message 12. However, when message 12 is received at nodes geographically located outside of the geographic target specified by the message, these non-intended recipient nodes 13 can disregard message 12 and, if warranted, forwards the message to neighboring nodes.

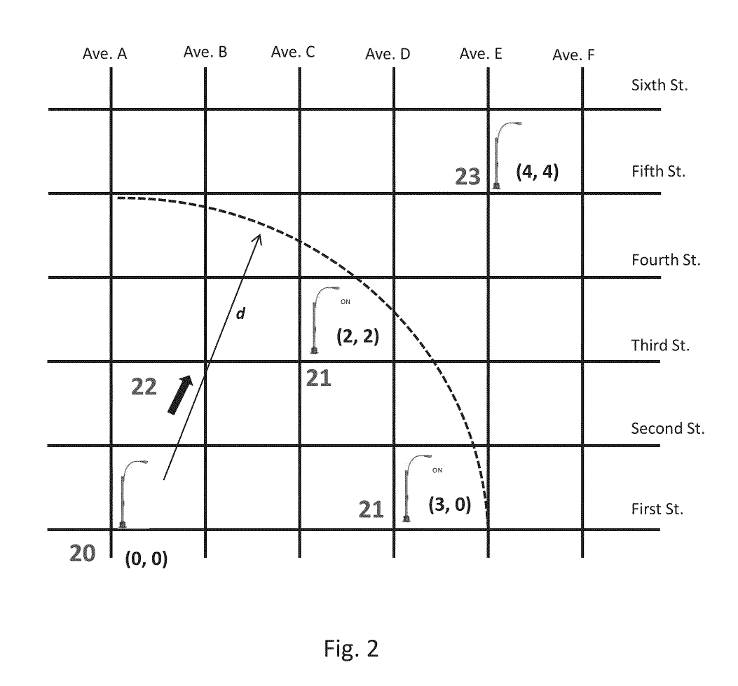

FIG. 2 illustrates another exemplary grid of streetlamps connected to form a geolocated network of nodes. As with the prior embodiment, the sender node 20 can be a central node with special-purpose command functionality or any other node in the network. In the example illustrated in FIG. 2, sender node 20 is an streetlamp node that communicates with nearby streetlamp nodes via wireless network connections. Wired connections or a combination of wired and wireless connections can also be used. Sender node 20 is geographically located at (0,0) and broadcasts a wireless message 22. The location of sender node 10 is incorporated into the node's address in the geolocated network (e.g., “0×0”). The geographic target of message 22 is the set of coordinates that are geographically located with a distance d of the sender node's 20 geographic location. The message content of message 22 includes the sender node's 20 geographic location and instructions commanding all intended recipient nodes—all streetlamp nodes located within distance d of the sender node's 20 geographic location—to immediately turn on those streetlamps.

In this wireless broadcast scenario of FIG. 2, all streetlamp nodes within the broadcast range utilized by the sender node 20 in dispatching message 22 are recipient nodes. The sender node can optimize its broadcast range and thus conserve power by limiting its broadcast range to that needed to reach the target location of the message 22. In the example illustrated in FIG. 2, both recipient nodes 21 (which are addressed in the geolocated network based on their location, e.g., “2×2,” “3×0”) receive the message 22 and based on the determination by these recipient nodes that each is located within distance d of the geographic location of the sender node 20, both of the recipient nodes 21 are determined to be intended recipients nodes of message 22. Upon determining they are intended recipient nodes 21, these nodes respond to the receipt of message 22 by processing the instructions provided in the message content of message 22 and switch on streetlamps located at these nodes. Additionally, recipient nodes 21 can be required to authenticate themselves in order to access the message content of the message 22.

Recipient node 23 (which is addressed in the geolocated network based on its location, e.g., “4×4”) is within the broadcast range used to dispatch message 22, but it determines that it is not geographically located within distance d of sender node's 20 geographic location and thus is not an intended recipient node of message 22. Consequently, recipient node 23 can disregard message 22.

The determination that recipient nodes 21 are intended recipients and that recipient node 23 is not an intended recipient is accomplished by comparing the address of these nodes to the target location of message 22. For example, the recipient node 21 geographically located at (2,2) would compare its address (e.g., “2×2”) to the target location of message 22 (i.e., the distance d from the sender node's 20 geographic location). Each recipient node of message 22 in the geolocated network would make a similar determination based on its geographic location encoded in its network address. The determination of whether a recipient node's geographic location is within the target location of the message can be made according to algorithms and calculations known in the art. However, no address or location lookups are required by a recipient node to determinate whether it is an intended recipient node since the geographic location of recipient node is encoded in its network address. If any lookups are required in determining whether a recipient node is an intended recipient node, these lookups would be incident to the calculation of whether the recipient node's location is within the target location of the message.

In this manner, alarm messages can be dispatched from a sender node without any knowledge of the geographic location of any devices that may respond to the alarm. In the example illustrated in FIG. 2, sender node 20 can broadcast an alarm message to all lighting devices within broadcast range of the sender node. In such a scenario, every recipient node is an intended recipient node as the geographic target of the alarm message is defined by the broadcast range of sender node 20. Instead of the widest possible distribution to all nodes within broadcast range, alarms can also be directed to nodes at specific locations or nodes located within a range of coordinates. This ability to direct alarms to recipients without knowledge of the geographic location information of the intended recipients is especially useful as the network grows in size. Otherwise, the ability to quickly dispatch alarms based on geographic location information is hindered in large networks where identifying the geographic location of potential recipients and translating between geographic and logical address information is prohibitively costly.

Also in this manner, messages can be dispatched in a geolocated network of mobile nodes, without any knowledge of the present locations of any individual nodes. In light of the difficulty in guaranteeing the present location of a mobile node, dispatching messages to target locations defined by sets of coordinates allows messages to be delivered based on a mobile node's general location and reduces the burden of maintaining precise location information for the nodes in the network. In the example of FIG. 2, the recipient nodes are all stationary streetlamp nodes. However, these recipient nodes could be any kind of mobile device. For instance, a geolocated network could be formed by a set of mobile advertising platforms with the capability of dynamically updating the advertising information that is displayed by the platform. For example, a mobile advertising vehicle can change its display based on commands received by the vehicle via a wireless connection. Through this wireless connection, this advertising vehicle is a node within a geolocated network of nodes, each node being a component of this advertising system.

This wireless connection allows the vehicle to communicate with a central command unit or other components of the advertising service that are nodes of the geolocated network. Via this wireless connection, the mobile node can update the central command unit with its current location and receive messages broadcast by the central command unit. However, rather than having to address each mobile advertising vehicle individually, the central command unit utilizing the present invention can direct a message to any vehicle within a defined proximity to a geographic location to display a specific advertising.

For example, an advertising service could direct its mobile vehicles to promote open seats for an upcoming showing at a movie theater. But, in order to target its advertising to viewers most likely to be able to attend this showing, the advertiser would want to direct all advertising assets, whether fixed or mobile, that are within 5 blocks of the theater. Using the geolocated network of the present invention, the central command unit can issue such a command without having to determine which advertising assets lie within that 5 block radius of the theater. Instead, the central command node dispatches a message on the geolocated network. Each recipient of the message determines if its present location is within the 5 block radius specified as the target location for the message.

In the context of the geolocated network illustrated in FIG. 2, sender node 20 can dispatch messages 22 to any mobile advertising platforms presently located within distance d (in this example, the broadcast range) of the sender node's geographic location. Message 22 could for instance include message content instructing recipient mobile advertising platforms to update their displayed advertising immediately to promote an upcoming event in the area. As with fixed-location nodes, mobile recipient nodes can be required to authenticate themselves in order to access message content. Every mobile advertising platform within broadcast range d of sender node would be a recipient node of message 22. As with fixed location nodes, each mobile advertising platform would determine if it is an intended recipient node by comparing its location, which is encoded in its network address and updated based on movements of the mobile advertising platform, to the target location of message 22 without performing location lookups or translating logical address information to geographic information.

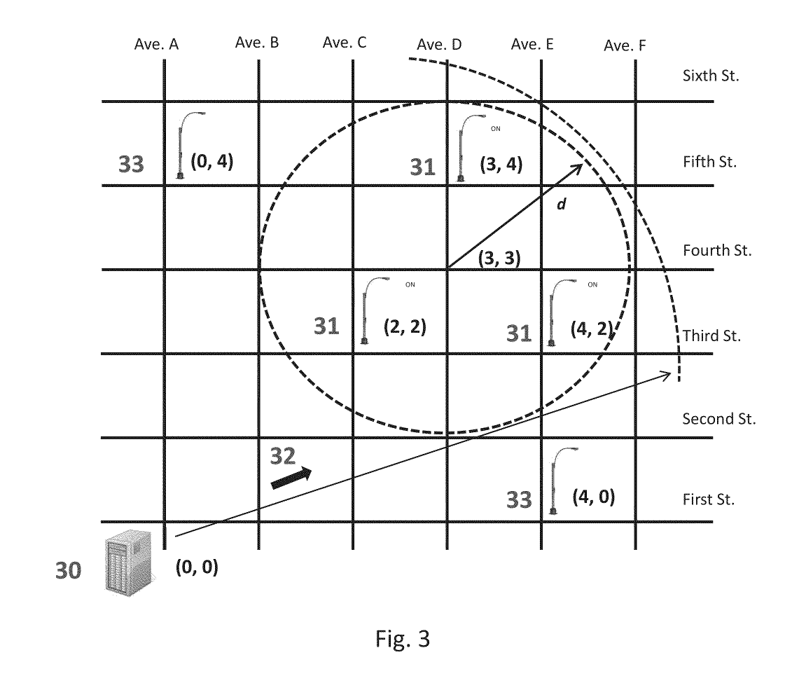

FIG. 3 illustrates another exemplary grid of streetlamps connected to form a geolocated network of nodes. Sender node 30 is a central node with special-purpose command functionality, but could be any other node in the geolocated network. Sender node 30 is geographically located at (0,0) and broadcasts a wireless message 32. The geographic target of message 32 is the set of coordinates that are geographically located with a distance d of the a specified geographic coordinate, (3,3). The message content of message 32 includes instructions commanding all intended recipient nodes—all streetlamp nodes located within distance d of (3,3)—to immediately turn on streetlamps located within the geographic target.

In this wireless broadcast scenario of FIG. 3, all streetlamp nodes within the broadcast range utilized by the sender node 30 in dispatching message 32 are recipient nodes. In the example illustrated in FIG. 3, recipient nodes 31 (which are addressed in the geolocated network based on their location, e.g., “2×2,” “3×4” and “4×2”) receive the message 32 and each recipient node 31 determines if it is an intended recipient node of message 32 by calculating whether the recipient node is geographically located within distance d of (3,3). The determination whether a recipient node is an intended recipient is accomplished by comparing the geographic location of the recipient node encoded in its network address to the target location of message with no address or location lookups required by the recipient node. The determination of whether a recipient node's geographic location is within the target location of the message can be made according to algorithms and calculations known in the art. Upon determining they are intended recipient nodes 31, these nodes respond to the receipt of message 32 by processing the instructions provided in the message content of message 32 and switch on streetlamps located at these nodes. Additionally, recipient nodes 31 can be required to authenticate themselves in order to access the message content of the message 32.

Recipient nodes 33 (addressed in the geolocated network based on their location, e.g., “0×4,” “4×0”) are within the broadcast range used to dispatch message 32, but these recipient nodes determine they are not geographically located within distance d of (3,3) and thus are not intended recipient nodes of message 32. Consequently, recipient nodes 33 can disregard message 32.

In this manner, a message can be dispatched to a set of destination nodes without any a priori knowledge about the location of these destination nodes. A target location that is a range of coordinates can be specified in a variety of ways. As illustrated in the example of FIG. 3, a range can also be a distance from a fixed point (e.g., all nodes with a location that is within 1000 meters of the GPS coordinates: 30.2664242, −97.7427826). A range can also be specified as a set of upper and lower bounds (e.g., all nodes located at a latitude greater than 33.30 degrees and less than 33.32 degrees and at a longitude less than −111.88 degrees and greater than −111.90 degrees). A range can also be specified as any polygon defined by a set of geographic coordinates.

As with the example illustrated in FIG. 2, the geolocated network of FIG. 3 can also be comprised of mobile nodes instead of fixed location nodes such as streetlamps. As mobile nodes change their geographic location, their network addresses are updated to reflect their current locations. Mobile nodes receive and processes messages the same as stationary nodes. Instead of stationary streetlamps, the geolocated network illustrated in FIG. 2 could be comprised of mobile advertising platforms. All mobile advertising nodes within broadcast range of message 32 would be recipient nodes and those mobile advertising nodes currently located within the target location of message 32 (i.e., within distance d of (3,3)), would be intended recipient nodes that would process the instructions provided in the message contents of message 32 and, for instance, update their displayed to promote an event occurring at location (3,3) based on instructions provided in the message content. All mobile recipient nodes not presently within distance d of location (3,3) would disregard message 32.

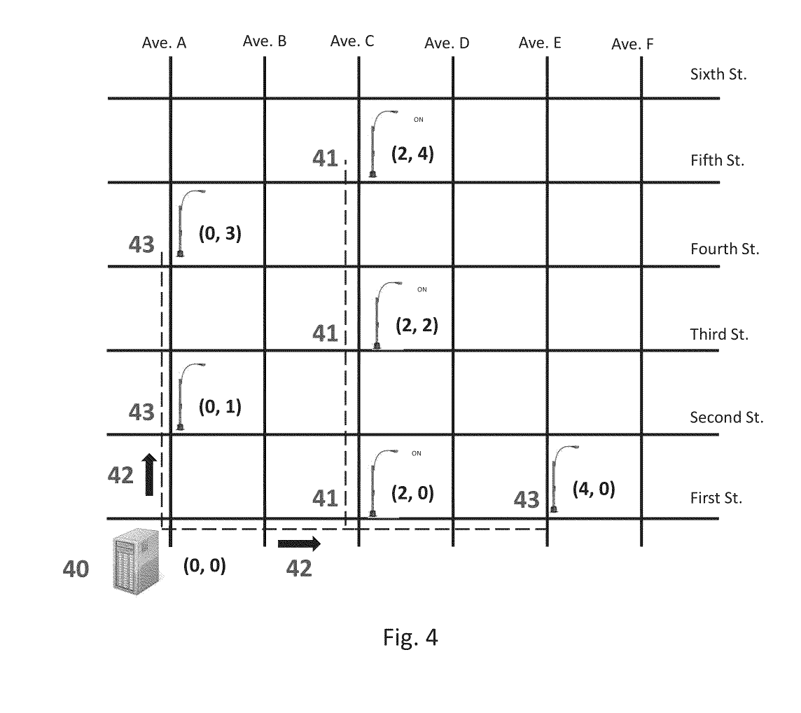

FIG. 4 illustrates another exemplary grid of streetlamps connected to form a geolocated network of nodes. Sender node 40 is a central node with special-purpose command functionality, but could be any other node in the geolocated network. Sender node 40 is geographically located at (0,0) and transmits a message 42 via wired connections to streetlamp nodes that are connected to sender node 40. The message content of message 42 includes instructions commanding all intended recipient nodes—all streetlamp nodes geographically located along Avenue C—to immediately turn on those streetlamps.

In the example illustrated in FIG. 4, message 42 is used to turn on all streetlamps located along Avenue C. Turning on streetlamps along Avenue C is accomplished by representing Avenue C in the target location of message 42 as a path of geographic coordinates. In this example of FIG. 4, the path information describing Avenue C is all points along the line from (2,0) to (2,5). This path information representing Avenue C is the geographic target of message 42.

Path information need not require action by nodes along the path from the sender to the target location. In other words, path information can serve as routing information that directs a message to be delivered along a particular path, but does not require action by any node other than the node located at the endpoint of the path. This allows path information to represent specialized routing instructions, such as geographic network constraints. For instance, in a wireless geolocated network, obstructions may prevent reliable signal delivery between two points on a network. Thus, delivery of messages between these two nodes may be accomplished using a delivery path that routes the message via a dogleg route around the obstructions. In this manner, path information can be utilized by the message target location to represent a variety of specialized routing instructions.

A variety of different ways for representing geographic path information would be appreciated by a person of ordinary skill. The example of FIG. 4 illustrates the representation of a path as all points along a single line segment. However, paths information could also be represented by a series of related line segments. Path information could also be represented as a series of waypoints between a starting location and an ending location. Path information could also be represented as a series of one or more geometrical shape such as an rectangles.

In the example of FIG. 4, message 42 is transmitted along the wired connections from sender node 40 to recipient node 41 located at (2,0) (which is addressed in the geolocated network based on its location, e.g., “2×0”) and recipient node 43 located at (0,1) (addressed based on its location, e.g., “0×1”). Message 42 is subsequently propagated along the wired connections joining the nodes of the geolocated network. Upon receipt at each recipient node, the geographic location of the recipient node encoded in its network address is compared to the path information specified in the target location of message 42. Recipient nodes 41 are all geographically located along the line from (2,0) to (2,5) and are thus intended recipient nodes.

As described previously, the determination whether a recipient node is an intended recipient is accomplished by comparing the geographic location of the recipient node encoded in its network address to the target location of message with no address or location lookups required by the recipient node. The determination of whether a recipient node's geographic location is within the target location of the message, including whether the recipient node is along a path to the target location, can be made according to algorithms and calculations known in the art.

The intended recipient nodes 41 respond to the receipt of message 42 by processing the instructions provided in the message content of message 42 and switches on streetlamps located at these nodes. Additionally, recipient nodes 41 can be required to authenticate themselves in order to access the message content of the message 42. Recipient nodes 43, however, determine they are not located along the path specified by the target information of message 42 and are thus not intended recipients. Consequently, recipient nodes 43 can disregard message 42.

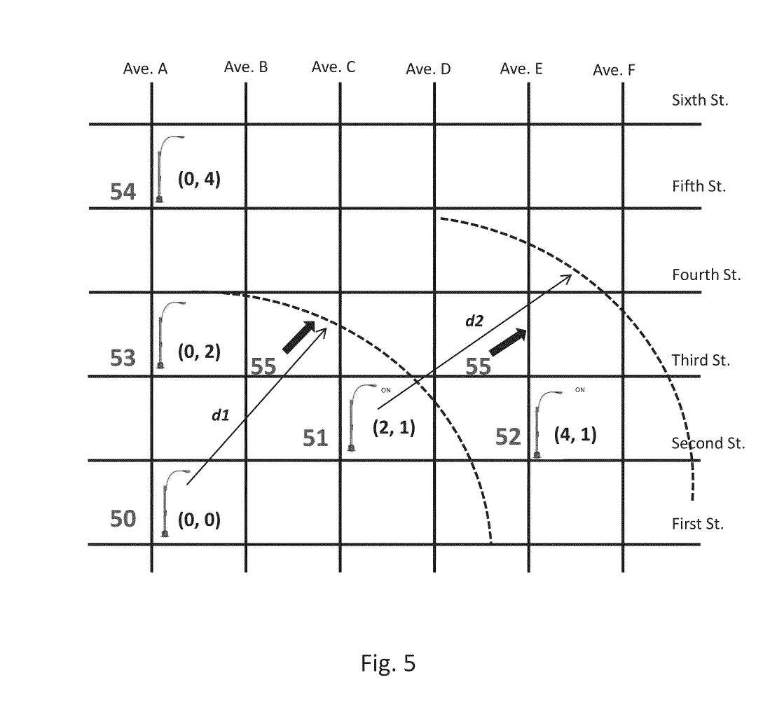

FIG. 5 illustrates another exemplary grid of streetlamps connected to form a geolocated network of nodes. Sender node 50 is a streetlamp node that communicates with nearby streetlamp nodes in the geolocated network via wireless network connections. However, sender node 50 could instead be a central node with special-purpose command functionality. In the example illustrated in FIG. 5, sender node 50 is geographically located at (0,0) and transmits a message 55 to all nodes geographically located with broadcast range d1 of sender node 50. The message content of message 55 includes the sender node's 50 geographic location and instructions commanding all intended recipient nodes—all streetlamp nodes located along the path from the sender node's geographic location to (4,1)—to immediately turn on those streetlamps.

The geographic target of message 55 is the path from sender node 50 to the streetlamp node geographically located at (4,1), recipient node 52. However, the target location of message 55 cannot be reached via a direct connection from sender node 50. This situation can result because the target location of message 55 is geographically located beyond the wireless broadcast range of the sender node 50. This situation can also result in a wired geolocated network when a sender node does not have a direct wired connection to a node at the target location. In these situations, the message must be relayed to the intended recipient node via one or more intermediary nodes.

In the example of FIG. 5, intermediary recipient node 51 serves a similar purpose to a server hosting a routing table in a conventional network. Similar to a conventional routing server, intermediary recipient node 51 (which is addressed in the geolocated network based on its location, e.g., “2×1”) receives message 55 and either delivers it to the target location specified by the message or forwards the message to another intermediary node in the network that is on a path to the target location. However, unlike a routing server in a conventional network, no address or location lookups are required in order for intermediary recipient node 51 to determine if it is an intended recipient node or to forward message 55 to its target location. The fact that any node in the network can provide routing services without maintaining a conventional routing database is a particular advantage provided by a geolocated routing. With every node able to provide routing services, messages can be propagated through large networks without the overhead and expense of maintaining dedicated routing servers.

Upon receiving message 55, intermediary recipient node 51 determines if it is an intended recipient of the message. This determination is accomplished by comparing intermediary recipient node's location (which is encoded in its network address, e.g. “2×1”) to the target location of message 55 (i.e., the path from the sender node's geographic location to (4,1)). Each recipient node of message 55 in the geolocated network would make a similar determination based on its geographic location encoded in its network address. This determination is made according to algorithms and calculations known in the art and is made using the location of recipient node 51 encoded in its network address without looking up the recipient node's geographic location. Intermediary recipient node 51 determines that it is an intended recipient node since its geographic location encoded in its network address (e.g., “2×1”) is along a path to (4,1). However, since intermediary recipient node 51 is not the endpoint of the path that is the target location, intermediary node 51 determines it must forward message 55.

Recipient node 53 (which is addressed in the geolocated network based on its location, e.g., “0×2”) also receives message 55 since it is geographically located within the wireless broadcast range dl of sender node 50 used to dispatch message 55. Upon receipt of message 55, recipient node 53 compares its location to the target location of message 55 and determines it is not an intended recipient node of this message because it is not geographically located at (4,1) (the endpoint of the path specified as the target location of message 55 and it is not along a path from sender node 50 to (4,1). This determination is made according to algorithms and calculations known in the art and is made using the location of recipient node 53 encoded in its network address without looking up the recipient node's geographic location. Based on this determination, recipient nodes 53 can disregard message 55 and does not forward the message to its neighboring network nodes, such as node 54 located at (0,4) which is not within the broadcast range dl of the initial broadcast of message 55 by sender node 50 and is thus not a recipient of message 55.

In order to forward a message towards the target location of a message, an intermediary node can distribute the message to all of its neighbors via a wireless or a wired broadcast. In this manner a message can be propagated throughout an entire geolocated network. A message can re-broadcast by intermediary nodes until all intended recipient nodes have received the message. The formation of endless loops in the message propagation paths can be prevented using techniques known in the art. However, the intermediary node can also selectively forward a message only if the intermediary node determines that it is on a path from the sender node to the target location. The intermediary node can utilize the target location and the location of the sender node to determine if its own location is on a path from the sender node to the target location. If the intermediary node determines it is not on a path to the target location, further propagation of the message by this intermediary node could be unnecessary. However, if the intermediary node determines it is located on a path from the sender node to the destination node, the intermediary node can proceed to forward the message along this path. Unlike conventional networks, routing determinations in a geolocated network can be made using only the location information provided in the message (e.g., the location of the sender node and the target location) and the location, encoded in a network address, of the intermediary node making the routing decision.

In the example of FIG. 5, intermediary recipient node 51 receives message 55 broadcast from sender node 50 since intermediary recipient node is within the broadcast range d1 of the sender node. Intermediary recipient node subsequently determines that it is not the endpoint, the location (4,1), of the path specified in the target location of message 55. Intermediary recipient node 51 makes this determination without routing table lookups by comparing the geographic location information encoded in its network address (e.g., “2×1”) to the target location endpoint. However, according to algorithms and techniques known in the art, intermediary recipient node 51 determines it is along a path from the sender node 50 to the endpoint of the path specified in the target location. Based on the instructions provided in the message content of message 55, intermediary recipient node also determines that nodes along the path specified by the message target location are instructed to turn on streetlamps at those locations. Consequently, intermediary node 51 determines that it is an intended recipient of message 55, even if it is not located at the endpoint of the path. Next, intermediary recipient node 51 re-broadcasts message 55. Since recipient node 52 is within the broadcast range d2 of intermediary node 51, recipient node 52 receives the re-broadcast message 55 from intermediary node 51. Based on its location information encoded in its network address, recipient node 52 determines that it is located at the endpoint of the path specified in the target location of message 55 and is thus an intended recipient of message 55. The intended recipient nodes 52 responds to the receipt of message 55 by processing the instructions provided in the message content of message 55 and switches on streetlamps located at these nodes. Additionally, recipient nodes 52 and all intermediary nodes that are determined to be intended recipients can be required to authenticate themselves in order to access the message content of the message 55.

As with the examples illustrated in FIGS. 2 and 3, the geolocated network of FIG. 5 can also be comprised of mobile nodes instead of fixed location nodes such as streetlamps. Mobile nodes must update their network addresses in order to reflect their current locations, but would otherwise send and receive messages within the geolocated network the same as stationary nodes. Instead of stationary streetlamps, the geolocated network illustrated in FIG. 5 could be comprised of mobile advertising platforms. All mobile advertising nodes within broadcast range d1 of message 55 would be recipient nodes and those mobile advertising nodes currently located within the target location of message 55 (i.e., the path from the sender node's geographic location to (4,1)) would be intended recipient nodes that would process the instructions provided in the message contents of message 55 and, for instance, update their displayed to promote an event occurring along this path. All other mobile recipient nodes not presently along this path would disregard message 55. And, the same as with a geolocated network of stationary nodes, mobile nodes that are not located at the specified endpoint of the path but are located along the path the endpoint would serve as intermediary nodes that forward a message to neighboring nodes by re-broadcasting the message.

In a conventional network consisting of mobile nodes, directly addressing a particular node is problematic. As opposed to a network of fixed-location nodes, not only can mobile nodes change geographic location, they can be in motion at any time. This limits the ability to deliver messages to these nodes based on geographic location. Since mobile nodes can move at any time, directly addressing mobile nodes based on their present location risks directing the message to a location where the node is no longer present. Maintaining an accurate, central database of the current location of every mobile node is itself a difficult task when nodes are in motion. This difficulty of incorporating mobile nodes in conventional networks is addressed by directions messages to mobile nodes based on ranges of geographic locations (e.g., any node that is presently within 1000 meters of the GPS coordinates: 30.2664242, -97.7427826).

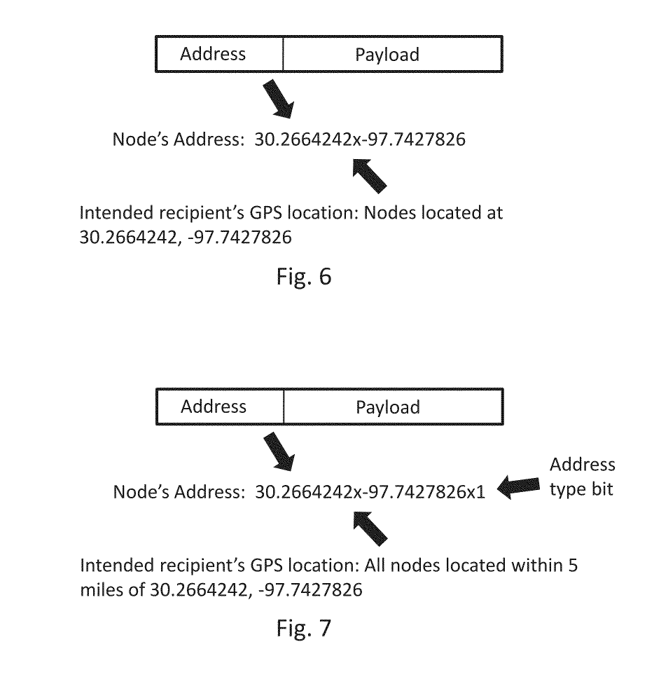

FIG. 6 illustrates an exemplary formation of a geolocated address for a recipient node and the use of the node's address as a message address. A message can be described as two pieces of information, an address of the intended recipient node and a message payload. As described above, the address for a message in a geolocated network according to various embodiments, identifies the geographic location of one or more intended recipient nodes. As illustrated in FIG. 6, a node's address can be comprised of its geographic coordinates. For instance, the address of a node located at the GPS coordinates 30.2664242, -97.7427826 can be formed by concatenating the coordinate information into a delimited string, such as 30.2664242x-97.7427826. Using such an address as a message address, a message can be directed to this node and any other nodes at these coordinates. The remaining message information, such as message content and routing instructions, would be included in the payload portion of the message.

FIG. 7 illustrates another exemplary formation of message address. In this embodiment, the message address includes not only an address for the intended recipient node, but also includes an additional bit specifying the type of message address that is being specified by this message. As describe above, a message can be directed, for instance, to recipient nodes at a specific geographic location, nodes located within a specified distance from a geographic location, or nodes located along a path to a specified geographic location. These can be considered different types of target locations for a message. The type of target location for a message can be specified in the content for that message. However, in order to speed processing of messages by recipient nodes, the target location type for a message can also be encoded into the message's address. As illustrated in FIG. 7, this can be accomplished using a message address type bit that can be appended to the message address. This bit can specify whether the message address is an exact location, a distance from a location, a region or any other type of target location. Having the message address type encoded into the message address allows a recipient node to determine if it needs to access the message content in order to evaluate whether further action is required. Or, if the message address type indicates that the message is directed only to nodes located at the message address, then all recipient nodes not at that location can disregard the message without accessing the message content.

This address type bit illustrated in FIG. 7 could also be used to specify the a precision level of the message address. In some cases, a message may be directed to an single location, but a sender would like to avoid delivery failures to intended recipients due to relatively minor addressing variances. For example, if an exact match between a message address and a recipients node's address is required for the recipient to be deemed an intended recipient then a node with address 30.2664242x-97.7427826 would not be an intended recipient of a message with address 30.2664241x-97.7427826. This problem can be addressed by using address type bits that specify the amount of precision required when comparing a message address to a node address.

Even though the embodiments described above represent metropolitan scale implementations of geolocated networks. Such networks can be can implemented on smaller scales. For example, a geolocated network can be implemented as a wireless mesh network, using a MiWi lighting protocol developed by Applicant. Each MiWi microcontroller would be a geolocated node in a network of nodes.

Another advantage provided the claimed geolocated network messaging system is the ability to easily commission new nodes and to direct the service of existing node. New nodes can be added to the geolocated network by establishing the network address of the new node as some form of its present geographic location via a central command node that monitors the network of nodes. For example, commissioning of new streetlamp node can be accomplished by printing a MAC address as a bar code or QR code (i.e., a two-dimensional bar code) on a new streetlamp device. Upon installation, the streetlamp device is configured with its network address, which encodes its geographic location. A mobile device can be used to scan the bar code and report the streetlamp (uniquely identified by its MAC address) at the location. The central command node can log this information and send a message to that geographic location with the MAC as the message content and specifying the network address for the new node, where the address encodes the geographic location of the node. As described, the message will be routed to the location of the streetlamp. Upon receipt of the message, the new streetlamp node will detect its MAC address in the message content and confirm its network address. Change in the locations of fixed-location devices can be reported in this same manner.

Although the foregoing specification describes specific embodiments, numerous changes in the details of the embodiments disclosed herein and additional embodiments will be apparent to, and may be made by, persons of ordinary skill in the art having reference to this description. In this context, the specification and figures are to be regarded in an illustrative rather than a restrictive sense, and all such modifications are intended to be included within the scope of this disclosure. Accordingly, the scope of the present disclosure should be determined by the following claims and their legal equivalents.

What is claimed is:

1. A method for communicating within a network of devices; the method comprising:
a. creating a network of nodes wherein nodes are created for devices in the network; and
b. identifying each node by an address wherein the address is formed using geographical information.

2. The method according to claim 1, the method further comprising:
a. transmitting a message within the network of nodes from a sender node to one or more geographic targets, wherein the message is comprised of message content;
b. receiving the message at the one or more recipient nodes, wherein each recipient node determines whether it is geographically located within the geographic targets of the message; and
c. processing the message content of the received message by a recipient node, if the recipient node determines it is located within any of the geographic targets of the message.

3. The method according to claim 2, the method further comprising:
a. transmitting the message wherein a geographic target of the message is comprised of path information;
b. determining whether the recipient node is geographically located within the one or more geographic targets of the messages by determining whether the recipient node is geographically located along a path specified by the path information; and
c. forwarding the message by the recipient node if the recipient node determines it is geographically located along a path specified by the path information but is not an endpoint of the path wherein the message is forwarded along the path specified by the path information.

4. The method according to claim 2, wherein the geographic target of the message consists of global positioning system (GPS) coordinates.

5. The method according to claim 2, wherein a geographic target of the message is a distance from a geographic location.

6. The method according to claim 2, wherein a geographic target of the message is a rectangle defined by a set of geographic coordinates.

7. The method according to claim 2, wherein a geographic target of the message is a polygon defined by a set of geographic coordinates.

8. The method according to claim 1, wherein the message includes an alarm notification.

9. The method according to claim 3, wherein the path information includes instructions for forwarding the message along a path specified by the path information.

10. The method according to claim 2, wherein the message is further comprised of a message address and a message address type bit that specifies the type of geographic target for the message.

11. A non-transitory computer accessible memory medium storing program instructions, wherein the program instructions are executable to communicate within a network of devices and to:
a. communicate messages within a network of nodes wherein nodes represent devices in the network;
b. identify each node by an address wherein the address is formed using geographical information.

12. The memory medium of claim 11, wherein the program instructions are further executable to:
a. transmit a message within the network of nodes to one or more geographic targets, wherein the message is comprised of message content;
b. receive a message within the network of nodes, wherein the message recipient determines whether it is geographically located within the geographic targets of the message;
c. process the message content of the received message, if the recipient determines it is located within any of the geographic targets of the message.

13. The memory medium of claim 12, wherein the program instructions are further executable to:
a. transmit the message wherein a geographic target of the message is comprised of path information;
b. determine whether the recipient is geographically located within the one or more geographic targets of the messages by determining whether the recipient is geographically located along a path specified by the path information;
c. forward the message if the recipient determines it is geographically located along a path specified by the path information but is not an endpoint of the path wherein the message is forwarded along the path specified by the path information.

14. The memory medium of claim 12, wherein the geographic target of the message consists of global positioning system (GPS) coordinates.

15. The memory medium of claim 12, wherein a geographic target of the message is a distance from a geographic location.

16. The memory medium of claim 12, wherein a geographic target of the message is a rectangle defined by a set of geographic coordinates.

17. The memory medium of claim 12, wherein a geographic target of the message is a polygon defined by a set of geographic coordinates.

18. The memory medium of claim 11, wherein the message includes an alarm notification.

19. The memory medium of claim 13, wherein the path information includes instructions for forwarding the message along a path specified by the path information.

20. The method according to claim 12, wherein the message if further comprised of a message address and a message address type bit that specifies the type of geographic target for the message.
